(19) United States
(12) Patent Application Publication
(10) Pub. No.: US 2004/0193785 A1
(43) Pub. Date: Sep. 30, 2004

(54) System for improving the performance of read/write testing in a hard drive

(76) Inventors: Fernando A. Zayas, Loveland, CO (US); Tomas Blazek, Santa Clara, CA (US)

Correspondence Address: SHELDON R. MEYER, ESQ., FLIESLER DUBB MEYER & LOVEJOY LLP, Fourth Floor, Four Embarcadero Center, San Francisco, CA, 94111-4156, US

(21) Appl. No.: 10/386,086

(22) Filed: Mar. 11, 2003

(51) Int. Cl. G06F 12/16

(52) U.S. Cl. 711/105

(57) ABSTRACT

A system and method that performs a high speed write and read testing from a simulated host to and from a media of an electronic storage device. In write operations, a FIFO segment which has been previously initialized with a fixed pattern has its slots repeatedly reused to write the media with only a small portion of each sector slot changing from sector to sector. For read operations, a FIFO segment has its slots repeatedly reused to read the media with only a small portion of search sector verified from sector to sector. The data of each sector slot of the FIFO segment may include varying data and fixed data. The varying data may include block address data and time stamp data.

### CROSS REFERENCE TO RELATED APPLICATIONS

The present application is related to the following United States Patents and Patent Applications, which patents/applications are assigned to the owner of the present invention, and which patents/applications are incorporated by reference herein in their entirety: U.S. patent application Ser. No. 10/______, entitled “METHOD FOR IMPROVING THE PERFORMANCE OF READ/WRITE TESTING IN A HARD DRIVE ”, filed on Mar. 11, 2003, Attorney Docket No. PANA1040us1, currently pending.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to memory read and write systems, and more particularly to high speed reading and writing to a hard drive using a FIFO segment. a hard drive, such as background SMART testing and factory self-testing, is performed by allocating large amounts of memory for performing the entire read and write operations. Before the write data is sent to the media, the data is first initialized by the on-board processor with a known pattern. When data is read from the media, the data is compared against the expected pattern. This same situation exists when an external computer is used to do R/W testing. Large buffers are allocated and initialized with a known pattern before the data is send to the storage device. In read operations, large buffers are allocated to read data from the device. When read data arrives, the contents are compared against the expected pattern. A system for performing this type of R/W operation in accordance with the prior art is illustrated in system 100 of FIG. 1.

System 100 includes computer 102 and drive 104 connected via an interface bus 106. The interface may be an ATA interface. Computer 102 includes processor 110, I/O system 112, and memory 114. Write data 120 containing a pattern of data resides within memory 114. I/O system 112 connects the memory 114 and processor 110 to the hard drive 104. Data is exchanged between the computer 102 and the hard drive 104 via the interface bus 106. Before write data 120 is written to a hard drive 104 from memory 114, the computer first obtains a buffer (not shown) within memory 114. Next, the computer fills the buffer with the entire pattern. After the buffer is filled with the entire pattern, the pattern is written to hard drive 104. After the write operation is complete, the computer configures a second buffer (not shown) and reads the entire pattern previously written to the hard drive to the second buffer. The read pattern is then compared against the expected pattern. The pattern is typically a function of the data address in the hard drive. This method of R/W testing from a computer to and from a drive uses large amounts of memory and is undesirably slow due to the buffer filling and the buffer comparing required.

Further, the method of writing entire write data and reading entire read data to and from a drive is not a representative test for many hard drives as they are used in the field. Hard drives may be required to receive, write, read and transmit large amounts of data in short periods of time. The testing system of the prior art is not able to operate quickly enough to stress hard drive read and write operations while simultaneously checking for errors.

What is needed is a system and method for improving the performance of R/W testing in a hard drive that addresses the disadvantages of the prior art.

### SUMMARY OF THE INVENTION

The present invention provides a system and method for performing R/W testing in a hard drive. In one embodiment, a processor internal to the hard drive operates as a simulated host to perform read and write operations to the media. A first-in-first-out (FIFO) segment within the drive is used to implement a high speed read and write buffer while minimizing the memory and time required to perform these operations. A data pattern is written to the range of sectors on the media to be tested. In one embodiment, the data includes both a fixed pattern data and varying data. The varying data may be a function of the sector address, a time stamp, or some other type of varying data easily predicted by the simulated host. In a write operation, the simulated host releases sectors of the FIFO to write to the media. In one embodiment, the FIFO is initialized with the fixed data and the simulated host writes varying data to specified portions of the FIFO. In a read operation, the simulated host first waits for data to be made available in the FIFO a sector at a time, checks the data, and then releases the sector to be re-used by the FIFO segment. In one embodiment, the processor only reads the varying portion of the data to verify it matches a predicted varying data. In another embodiment, the entire contents of a sector are periodically checked to insure the sector contains the known data pattern.

### BRIEF DESCRIPTION OF THE DRAWINGS

FIG. 1 is an illustration of a prior art system used for R/W testing between a test computer and storage device.

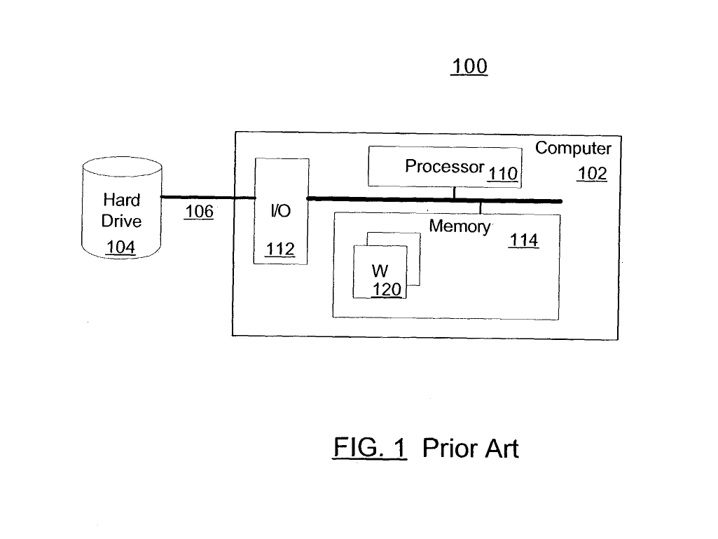

FIG. 2 is an illustration of a system for high speed R/W testing using a simulated host and the media of a storage device in accordance with one embodiment of the present invention.

FIG. 3 is an illustration of a method for performing a high speed simulated host write test using a FIFO segment in accordance with one embodiment of the present invention.

FIG. 4 is an illustration of a method for performing a high speed simulated host read operation from the media using a FIFO segment in accordance with one embodiment of the present invention.

FIG. 5 is an illustration of a method for verifying sector data in accordance with one embodiment of the present invention.

### DETAILED DESCRIPTION

The present invention provides an improved system and method for performing R/W testing within a rotating media storage device, such as a hard drive. In one embodiment, a hard drive's on-board computer operates as a simulated host to perform write, read, and compare operations to the media. A first-in first-out (FIFO) segment within the simulated host is used to implement high speed write, read, and compare operations while minimizing the memory and time required to perform the operations.

To accomplish write operations, a data producer (the simulated host) writes data to a FIFO segment and advances a producer pointer. In one embodiment, the data in each sector includes a varying data portion. The disk controller hardware acts as the consumer and writes the data to the media and advances a consumer pointer. The consumer must wait for the producer to make data available for the write to the media to continue. To accomplish read operations, the data producer (in one embodiment, the disk controller reading from the media) reads sectors from the media into the FIFO segment and advances the producer pointer. The data consumer (the simulated host in the read operation discussed above is now the consumer) checks the data of each sector as it becomes available and advances the consumer pointer. The consumer must wait for the producer to make data available for the comparison of data read from the media to continue.

In one embodiment, a FIFO segment is a ring buffer consisting of an integral number of sector-sized memory slots. In one embodiment, a sector is typically 512 bytes. As pointers are advanced from sector slot to sector slot within the FIFO segment, a wrap occurs at the end of the FIFO segment back to the start of the FIFO segment. This is a typical implementation in storage device controllers. Each FIFO segment has associated with it a consumer and producer pointer. Each pointer points to a sector-sized slot in the FIFO segment. As data is added, or produced, to the FIFO segment one sector at a time, the producer pointer advances to the next sector-sized slot. As data is removed, or consumed, from the FIFO segment one sector at a time, the consumer pointer advances to the next sector-sized slot. Both the consumer pointer and producer pointer will wrap to the start of the FIFO segment when they each reach the end of the FIFO segment. The producer does not overrun the consumer. In short, the FIFO segment serves as a speed match buffer between the consumer and the producer, where the consumer and producer may be the host interface and the media interface in a storage device, or vice versa.

In one embodiment, high speed R/W testing in this invention may be achieved by having the simulated host, an on-board processor in the rotating media storage device, reference the data infrequently. In typical hard drive controller designs, access to the data memory is slow. Data memory access usually involves accessing DRAM via a buffer controller, where the buffer controller is shared between multiple ports such as the host interface and the disk interface. In an embodiment of the present invention, the amount of data being changed or compared by the simulated host is limited to only a few bytes per sector. With such small amounts of data processed per sector, the on-board processor can keep up with the media read and write rates and perform testing “at speed”, or at generally the same speed that the media is written or read. As discussed above, the simulated host may be implemented as a processor internal to the hard drive. The processor may be implemented using an ARM-type processor, a digital signal processing (DSP) processor such as those manufactured by Texas Instruments, microprocessors such as the SGS Thomson Microelectronics (STM) Super 10, and other processors that may be appropriate for use in electronic storage devices. For purposes of discussion, the internal processor will be referred to hereinafter as an ARM processor. However, referral to the internal processor as an ARM processor is not intended to limit the scope of the present invention to encompass only an ARM processor.

An electronic storage device of the present invention may perform R/W testing in real-time. Data is produced in a simulated host during write operations to keep up with the media writing elements and data is consumed or verified during read operations while keeping up with the media reading elements. By doing the testing in real-time, an electronic storage device more closely simulates the behavior of real hosts while also providing for the verification of the data.

In one embodiment, the present invention writes data to a hard drive from a simulated host, reads the data back from the disk to the simulated host, and tests only a portion of the read data. In this embodiment, other testing procedures are used to test the data not tested by the simulated host. In one embodiment, and as is typical in the field, error correcting codes (ECC) confirms that the data is read correctly from the media. This method of R/W testing verifies that the data is written to and read from the proper locations on the media. In this manner, the small varying data portion of each sector is a function of the address of the data on the media.

In one embodiment, a subroutine of the simulated host inserts a small varying data portion into each sector during write operations and verifies the small varying portion from each sector during read operations. This subroutine may be run at each sector by the interrupt service routine that closes the servo loop for each sector. In this embodiment, the servo interrupt service routine may be run as the fast interrupt request (FIQ) of an ARM processor. Alternatively, the servo interrupt service routine may instead be run as a non-maskable-interrupt (NMI) of another type of processor, or as a high-priority interrupt request (IRQ) of either an ARM processor or another type of processor.

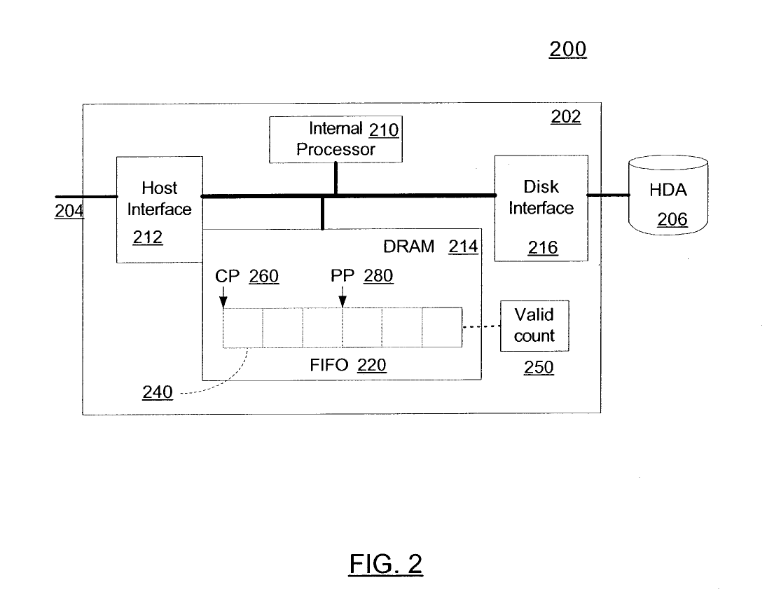

FIG. 2 is a block diagram for an electronic storage device (ESD) 200 with emphasis on the electronics portion 202 in accordance with one embodiment of the present invention. ESD 200 includes internal processor 210, host interface 212, DRAM 214, disk interface 216, and HDA 206. In an embodiment illustrated in FIG. 2, the on-board ARM CPU 210 serves as the simulated host. It is understood that the ARM CPU 210 includes the processor, internal memories, caches, bus interface unit, and other elements that allow it to interface to the bus that attaches to the host interface 212, the disk interface 216, and the DRAM buffer 214. In the DRAM buffer 214, at least one FIFO segment 220 is configured. Each FIFO segment consists of an integral number of sector-sized slots 240. In one embodiment, the sector size is 512 bytes. The FIFO segment 220 is used for performing input and output between the simulated host executing within CPU 210 and media of the HDA 206.

In one embodiment, the FIFO is a block of consecutive memory address locations having a beginning address and an ending address. A producer pointer (PP) 280 and a consumer pointer (CP) 260 are associated with the FIFO segment 220. During simulated host write operations, the producer pointer 280 points to the next sector in the FIFO to be modified by the simulated host 210 and the consumer pointer 260 points to the next FIFO sector to be written to the media. During simulated host read operations, producer pointer 280 points to the slot in the FIFO segment that will receive the next sector that is read from the media and consumer pointer 260 points to the next sector to be verified by the simulated host 210. At any time, a valid count 250 holds the number of “produced” sectors of the FIFO not yet “consumed”. As will be seen later, this valid count can be negative. The valid count 250, consumer pointer 260, producer pointer 280 are typically part of the hardware that manages FIFO segment operations.

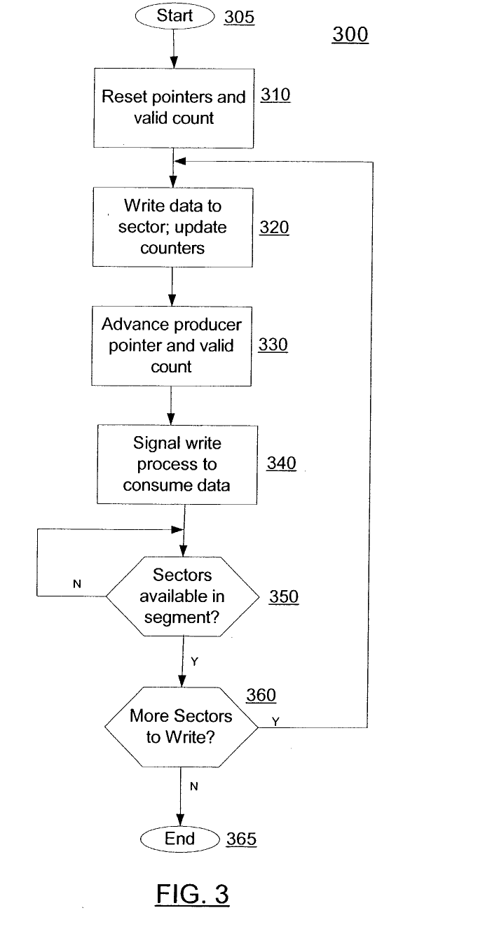

A method 300 for performing a high speed simulated host write test using a FIFO segment in accordance with one embodiment of the present invention is illustrated in FIG. 3. Method 300 is used to write a number of sectors worth of data to a range of sectors on the media. A segment of code in C++ that may be used to implement method 300 is shown below. Code lines are labeled with reference numbers 371-376 for purposes of discussion only.

| | |
|---|---|
| fifoSegment->ResetPointers( ); | 371 |
| for( int i=0; i<sectorsToWrite; i++ ) { | 372 |
| fifoSegment->producerP->Head.blockAddress = blockAddress; | 373 |
| fifoSegment->producerP->Head.timeStamp = globalIOCount; | |
| fifoSegment->producerP->Tail.blockAddress = blockAddress++; | |
| fifoSegment->producerP->Tail.timeStamp = globalIOCount++; | |
| fifoSegment->SectorProduced( ); | 374 |
| StartOrContinueDiskWrite( ); | 375 |
| fifoSegment->WaitForSectorAvailable( ); | 376 |
| } | |

Method 300 begins with start step 305. Next, the pointers and valid count are reset at step 310 the code above, the ResetPointers 371 initializes the consumer and producer pointers and associated hardware referring to the fifoSegment. In one embodiment, the FIFO segment to be used is initialized with the test pattern. In this embodiment, the FIFO segment is filled with the test pattern-such that the segment contains a fixed data pattern. Since the data pattern repeats for each sector or group of sectors within the FIFO segment, the fixed data pattern need only be configured once for the entire FIFO segment. The fixed data pattern is not changed as the producer pointer and consumer pointer are incremented and wrapped around the FIFO segment.

Next, varying data is written to the current sector slot within the FIFO, as indicated by the value of the producer pointer, at step 320 and line 373. In one embodiment, the varying data includes block address information. In another embodiment, the varying data includes time stamp information. The time stamp may be implemented in a variety of ways, including counting the number of I/Os issued as shown in lines 373. In this embodiment, both the block address and time stamp are included in the varying data. After a block of varying data is written, the producer pointer is advanced to the next sector slot in the FIFO segment and the count of valid sectors is incremented at step 330. The simulated host then signals the media write process that at least one more sector is available to be written at step 340. At this point, the simulated host pauses at step 350 until at least one available sector slot is present in the FIFO segment. It may be during this pause that the (asynchronous) media write process occurs. This feature is discussed in more detail below with respect to the code containing line 671. As is understood by anyone skilled in the art of storage device programming, the method WaitForSectorAvailable 376 also handles timeouts and conditions where the write operation fails and stops. If all sectors have been written to the FIFO, then operation ends at step 365 and the for loop 372 ends.

In the simulated host write code above, the for loop 372 executes the steps in the loop for as many sectors as is needed to write, sectorsTo Write. For each sector in the embodiment shown, two varying portions of the sector are initialized, the Head and Tail portions, with the blockAddress and globalIOCount in 373. Thus, each sector has the first eight bytes in this embodiment initialized with the block address and a time stamp (which is counting sectors written rather than elapsed time in this embodiment). The last eight bytes of each sector is likewise initialized in this embodiment. In the embodiment where the FIFO is pre-filled with a fixed expected pattern, a fixed pattern is enclosed between the two eight byte varying portions on the media after the write operation is complete. In one embodiment, the varying portions bracket the sector to detect split sectors that may originate from different tracks during a read portion of the test. In another embodiment, a varying portion is placed at the end of each sector to detect missing or double clocked data during write or read operations, either of which would misplace the last few bytes. It is understood that the location and amount of varying data may be adjusted to satisfy many factors. One consideration in this embodiment was the depth and timing of the write buffer implemented by an ARM core. In the remaining steps of the code, SectorProduced 374 advances the producer pointer and tells the hardware that one more sector is available in the fifoSegment. StartOrContinueDiskWrite 375 starts or continues the write operation to the media. Finally, WaitForSectorAvailable 376 stalls us in the loop until at least one more sector is available to be “produced”. Timeouts and exceptions that may be used in the present invention are not shown in the code above. However, those knowledgeable in the art of programming electronic storage devices understand that traps and methods could be used with the present invention and are be considered within the scope of the present invention. For example, handled without exceptions, the method WaitForSectorAvailable 376 could be coded as follows: if (fifoSegment−>WaitForSectorAvailableOrTimeout( )!=noError) break;.

In one embodiment, the fixed pattern may be designed to stress different portions of the read and write path. One type of or portion of a pattern may be designed to stress adjacent bit positions. Another type of or portion of a pattern may be designed to stress the DRAM controller and memory. Other patterns may be designed to stress ISI (Inter-Symbol Interference) on the media, overwrite on the media, and so on. In another embodiment, the fixed pattern is a non-repeating pattern easily predicted by an algorithm. In one embodiment, the fixed pattern is a simple repeating pattern. Those skilled in the art of testing understand these choices and also understand that these may be mixed to form one fixed pattern. One embodiment uses a random pattern where the first few bytes of the fixed pattern are the seed for a random number generator, allowing the recreation and checking of the pattern having only the seed available.

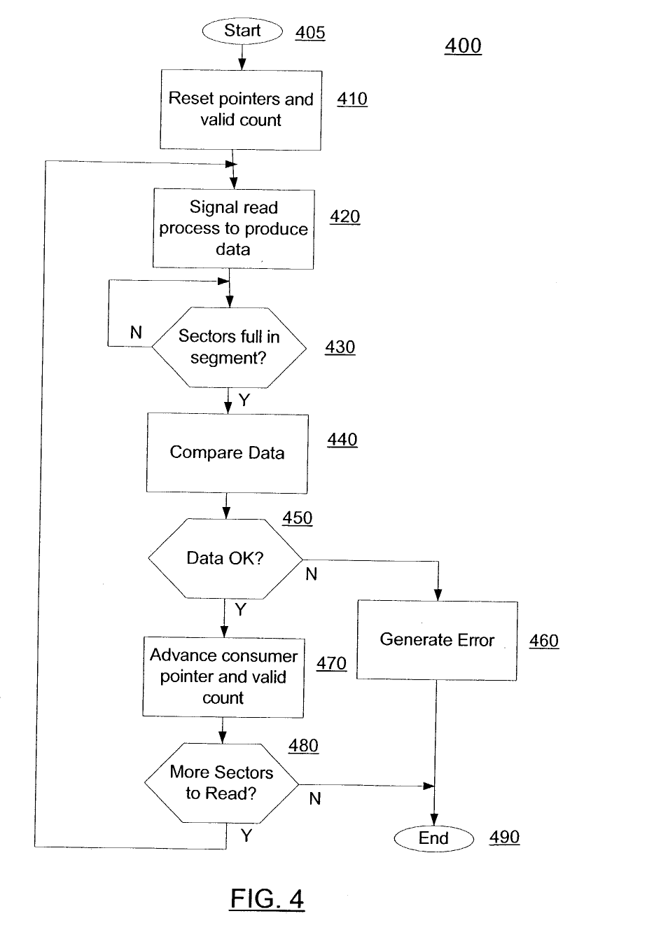

In one embodiment, the simulated host may act as the consumer and read data from the media. A method 400 for performing a high speed simulated host read operation from the media using a FIFO segment in accordance with one embodiment of the present invention is illustrated in FIG. 4. A portion of code in C++ that may be used to implement method 400 is shown below. The code lines shown below are labeled with reference numbers 471-477 for purposes of discussion only.

| fifoSegment->ResetPointers( ); | 471 |
|---|---|
| for( int i=0; i<sectorsToRead; i++ ) { | 472 |
| StartOrContinueDiskRead( ); | 473 |
| fifoSegment->WaitForSectorFull( ); | 474 |
| if ( fifoSegment->consumerP->Head.blockAddress != blockAddress | 475 |
| ∥ fifoSegment->consumerP->Tail.blockAddress != blockAddress ) break; | |
| blockAddress++; | 476 |
| globalIOCount++; | |
| fifoSegment->SectorConsumed( ); | 477 |
| } | |

Method 400 begins with start step 405. Next, the consumer and producer pointers and the valid count are reset in step 410. The asynchronous read process is then signaled to start or continue “producing” data from the media in step 420. Once the signaled, the read process reads data from the media and writes data to the FIFO segment. The system then determines if at least one sector has been read from the media to the FIFO segment at step 430. If a sector has not been completely read from the media and written to the FIFO segment, operation stays at step 430 until a sector of data is ready (timeouts and exceptions are not shown for clarity). If a complete sector of data is available to be read from the FIFO segment, data from the sector is read and compared to the expected data at step 440. In one embodiment, only a portion of data from each sector is read from the FIFO segment. The portion of data from each sector may include varying data. The varying portion of data may be located at a predetermined position within each sector in the media. In one embodiment, the varying portion of the data may be located in the beginning of a sector, end of a sector, or multiple locations within a sector. In yet another embodiment, the varying data is located in the first eight bytes of the sector, the last eight bytes of the sector, or at both the first and last eight bytes of the sector. As discussed above, the varying data could include block address information, time stamp information, or both. If the data compared matches the expected data at step 450, then operation continues to step 470. If the data compared does not match the expected data, an error is generated and logged at step 460 and operation ends at step 490. At step 470, the sector just compared is “consumed” in that the consumer pointer is incremented to the next FIFO segment slot and the valid count is decremented. Finally, at step 480, if no more sectors are to be read, then operation ends at step 490. If more sectors are to be read from the media, operation continues to step 420. The asynchronous read process is not shown, but anyone skilled in the art of storage device programming understands the process by which a combination of hardware and firmware “produces” data into a FIFO segment as sectors are read from the media.

In another embodiment of the present invention, the read process is signaled less than every sector read during operation of method 400. In yet another embodiment, the read process is signaled only once during operation of method 400. Though not illustrated in FIG. 400, these variations of method 400 are considered within the scope of the present invention.

With reference to the code lines 471-477 associated with method 400, sectorsToRead sectors are read from some blockAddress of the media. A FIFO segment fifoSegment is used for the read operation. The ResetPointers 471 initializes the consumer and producer pointers and associated hardware referring to the fifoSegment. The steps in the for loop 472 are executed as many times as there are sectors to be read, sectorsToRead. In StartOrContinueDiskRead 406, the asynchronous read operation starts or continues to read from the media using the fifoSegment. In WaitForSectorFull 474 the for loop is stalled until at least one sector of data is ready from the media in the fifoSegment. Once at least one sector is available, the code verifies that at least a portion of the data is correct. In the embodiment shown, the code verifies that the two varying portions of the sector, the Head and Tail portions, contain the expected blockAddress in 475. As described above, each sector may have the first eight bytes in this embodiment initialized with the block address and a time stamp. The time stamp may be counted I/Os issued rather than elapsed time in this embodiment. The last eight bytes of each sector may also be likewise initialized in one embodiment. It is understood that the location and amount of varying data may be adjusted to satisfy many factors. In the remaining lines of code, the code increments blockAddress and globalIOCount in 476 for subsequent sectors read. Finally, SectorConsumed 477 advances the consumer pointer and notifies the hardware that one more sector is available to be used by the read hardware in this fifoSegment. Timeouts and exceptions were eliminated from the code above for purposes of simplifying the example discussed. One knowledgeable in the art of electronic storage device testing would understand such traps are needed. For example, handled without exceptions, the method WaitForSectorFull 474 could be coded as follows: if (fifoSegment−>WaitForSectorFullOrTimeout( )!=noError) break;).

In another embodiment of the present invention, the fixed portion of the sector data pattern is verified. A portion of code in C++ that may be used to implement verifying the fixed portion of the sector data pattern in accordance with this embodiment is shown below. The code lines shown below are labeled with reference numbers 571-578 for purposes of discussion only.

| fifoSegment->ResetPointers( ); | 571 |
|---|---|
| for( int i=0; i<sectorsToRead; i++ ) { | 572 |
| StartOrContinueDiskRead( ); | 573 |
| fifoSegment->WaitForSectorFull( ); | 574 |
| if ( fifoSegment->consumerP->Head.blockAddress != blockAddress | 575 |
| ∥ fifoSegment->consumerP->Tail.blockAddress != blockAddress ) break; | |
| if ( (globalIOCount % fullCheckPeriod) == 0 ) | 576 |
| fifoSegment->VerifyFixedPortion( ); | |
| blockAddress++; | 577 |
| globalIOCount++; | |
| fifoSegment->SectorConsumed( ); | 578 |
| } | |

When executed, the code above periodically checks the fixed portion of the sector pattern. As coded in statements 576, at every fullCheckPeriod of sectors read, the fixed portion of the sector at the consumer pointer is checked to verify it contains the correct fixed portion (however composed—it can be a repeating pattern or a random pattern whose seed is the first element of the fixed portion or a mixture of patterns). For example, if fullCheckPeriod had a value of 10,000, then every 10,000^{th} sector read would be checked to have the correct fixed portion.

An alternate embodiment for checking the fixed portion of the sector data involves performing the fixed pattern verification on a sampled basis. This embodiment may utilize cycles available in the processor that would otherwise go unused. A portion of code in C++ that may be used to implement a sampled verification of the fixed portion of the sector data pattern in accordance with this embodiment is shown below. The new code lines shown below are labeled with reference number 671 for purposes of discussion only.

```
fifoSegment->ResetPointers( );
for( int i=0; i<sectorsToRead; i++ ) {
    StartOrContinueDiskRead( );
    fifoSegment->WaitForSectorFull( );
    if ( fifoSegment->consumerP->Head.blockAddress != blockAddress
      ∥ fifoSegment->consumerP->Tail.blockAddress != blockAddress ) break;
    if ( patternType == fixedPattern
      && ( fifoSegment->consumerP->sample1 != patternKey 671
        ∥ fifoSegment->consumerP->sample2 != patternKey
        ∥ fifoSegment->consumerP->sample3 != patternKey ) ) break;
    if ( (globalIOCount % fullCheckPeriod) == 0 )
      fifoSegment->VerifyFixedPortion( );
    blockAddress++;
    globalIOCount++;
    fifoSegment->SectorConsumed( );
}
```

In lines 671 above, the processor may repeatedly remain in an idle state while waiting for a new sector of data to be produced. In an embodiment that utilizes this idle time, one or more locations of a fixed pattern within the last sector written can be checked for every sector read from the media. In the example above, the code lines at 671 check three locations of the sector at offsets of sample1, sample2 and sample3 from the consumer pointer. This is for illustration purposes only, and any number of samples can be checked as long as the processor remains in an idle state.

Code execution stalls at WaitForSectorFull may be caused by head motion (head switch or seek), a re-read, or some other drive event. To accomplish a check in this embodiment, the simulated host consumer may run a little behind the media reads, as will be understood by those in the field of ESD R/W operation. In one embodiment, the simulated host or controlling system may release all but the last N sectors in the FIFO segment to subsequent read operations, where N is less than then number of sectors within the FIFO segment. An easy way to accomplish this is to initialize the valid count to −N instead of zero and understating the size of the FIFO segment by N. When a stall occurs, the simulated host still holds N sectors of the FIFO segment under its control (it has not released the sectors to the disk read operation) and can verify the fixed portion of these sectors. In one embodiment, the verify operation will attempt to verify the fixed portion of the N sectors held by the simulated host while checking if the stall condition has passed (the retry or head motion is complete and at least one new sector is available in the FIFO segment). If the stall condition has passed, the verify is aborted and operation continues with the process of verifying only the varying portions of the sector just arrived. In one embodiment, N is set in consideration of the speed of the simulated host doing a fixed portion verify and the time distribution of head motion and retries. In another embodiment, N may be set as large as possible without slowing down R/W testing. In the preferred embodiment, N=1.

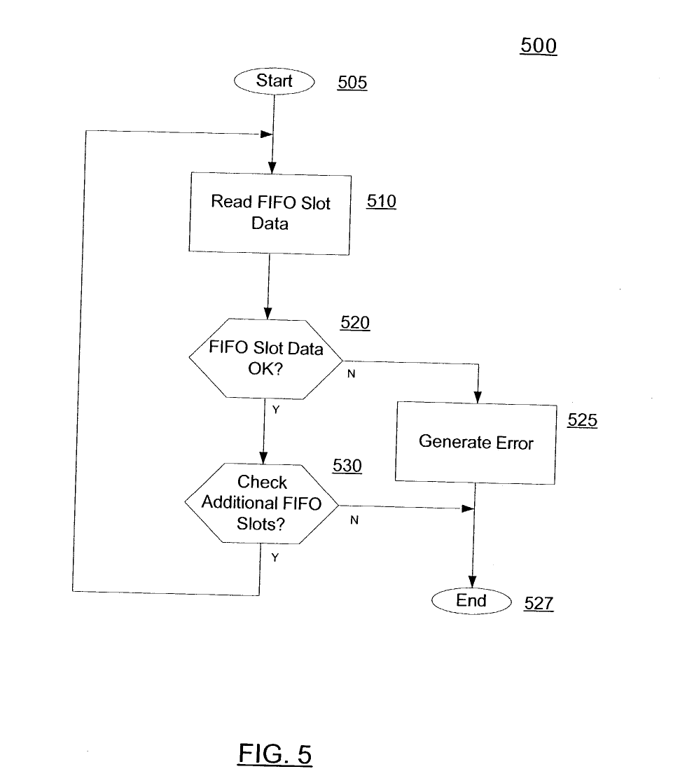

A method 500 is illustrated in FIG. 5 that may be executed by the simulated host or other hard drive internal processor concurrently with the loop of step 430 of method 400 when a sector is being read from the media. Method 500 begins with start step 505. Next, data in a FIFO slot is read at step 510. A portion of the FIFO segment slot containing a fixed pattern is then checked to verify it matches a predicted fixed pattern at step 520. If the read fixed pattern does not match the predicted fixed pattern, an error is generated at step 525 and operations ends at step 527. If the read fixed pattern matches the predicted fixed pattern, operation continues to step 530. At step 530, the simulated host or controlling system determines whether additional slots are to be checked. If no additional FIFO slots are to be checked, operation ends at step 527. If additional slots are to be checked, operation continues to step 510 where the next slot is read. In one embodiment where method 500 is configured to occur during a stall, if at any time during operation of method 500 the stall condition has passed, operation of 500 is terminated.

In one embodiment, including a time stamp in the initialization step in the for loop 373 above serves to mark when an error occurs, either in time or in sectors transferred, during a test. A portion of code in C++ that may be used to implement a time stamp in accordance with this embodiment is shown below. The code lines shown below are labeled with reference number 771 for purposes of discussion only.

```
fifoSegment->ResetPointers( );
for( int i=0; i<sectorsToRead; i++ ) {
    StartOrContinueDiskRead( );
    fifoSegment->WaitForSectorFull( );
    if ( triggerCount && (triggerCount == globalIOCount) ) 771
      break;
    if ( fifoSegment->consumerP->Head.blockAddress != blockAddress
      ∥ fifoSegment->consumerP->Tail.blockAddress != blockAddress ) break;
    if ( patternType == fixedPattern
      && ( fifoSegment->consumerP->sample1 != patternKey
        ∥ fifoSegment->consumerP->sample2 != patternKey
        ∥ fifoSegment->consumerP->sample3 != patternKey ) ) break;
    if ( (globalIOCount % fullCheckPeriod) == 0 )
      fifoSegment->VerifyFixedPortion( );
    blockAddress++;
    globalIOCount++;
  fifoSegment->SectorConsumed( );
}
```

If the test conditions for which an error occurred can be repeated (the test parameters are generated from pseudo random number generators with known keys and other test conditions are recorded), then the sequence leading to a failure can be reproduced. This is a valuable aid to resolving the underlying failure mechanism. In one embodiment as shown in the if statement 771, one of the parameters of the test will stop the test after a given number of sectors are transferred.

The present invention provides an improved system and method for performing read/write testing in a rotating media storage device. An on-board processor within a storage device operates as a simulated host which performs read and write operations to its media. A FIFO segment within the device is used to implement high speed read and write operations while minimizing memory and time required to perform the operations. In one embodiment, the sectors written to and read from the media include a fixed portion bounded by two varying portions. For write operations, the proper fixed and varying portions are sent to the media. For read operations, the varying portions are always verified. In one embodiment, the fixed portion is periodically completely verified. In one embodiment, the fixed portion is checked on a sampled basis.

In one embodiment, both the fixed and variable portions of all sectors read are checked in some sense by the hardware error correction code (ECC). As known by those in the art of electronic storage device testing, the ECC will test the sector data read back from the disk media. In one embodiment, if errors exist in a sector of data read from the disk media and tested by the ECC, the errors will be small enough such that the ECC can correct them or that the ECC can determine an error exists. The ECC can be configured to generate an error signal in the case that a defect is detected larger than a predetermined threshold. In another embodiment, the ECC can be configured to generate an error message when a defect is detected that could not be fixed by the ECC. The ECC may be configured to test data in R/W test operation in addition to the testing methods discussed above.

As will be known to those skilled in the art of memory testing, the FIFO segment of the present invention can be implemented in plurality to perform R/W testing as discussed herein. Thus, more than one FIFO segments as described herein could be used to simultaneously perform R/W tests to an ESD storage media.

The present invention provides a system and method for performing R/W testing in a hard drive. In one embodiment, a drive on-board processor operates as a simulated host to perform read and write operations to the media. A first-in-first-out (FIFO) segment within the drive is used to implement a high speed read and write buffer while minimizing the memory and time required to perform these operations. In one embodiment, a data pattern is written to the range of sectors on the media to be tested. In one embodiment, the data includes both a fixed pattern data and varying data. The varying data may be a function of the sector address, a time stamp, or some other type of varying data easily predicted by the simulated host. In a write operation, the simulated host releases sectors of the FIFO to write to the media. In one embodiment, the FIFO is initialized with the fixed data and the simulated host writes varying data to specified portions of the FIFO. In a read operation, the simulated host first waits for data to be made available in the FIFO a sector at a time, checks the data, and then releases the sector to be reused by the FIFO segment. In one embodiment, the simulated host only reads the varying portion of the data to verify it matches a predicted varying data. In another embodiment, the entire contents of a sector are checked to insure the sector contains the known data pattern.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing an improved method and system for performing R/W operations to the drive as discussed herein.

1. An electronic storage device for performing high speed R/W testing comprising:
a FIFO segment configured to have in integral number of slots, the FIFO segment configured with a producer pointer and a consumer pointer, the producer pointer configured to indicate the next available FIFO slot to which a data block can be written to, the consumer pointer configured to indicate the next available FIFO slot from which a data block can be read from;
an internal processor configured to write a first data block to the FIFO segment; and
a media R/W system configured to read the first data block from the FIFO segment and write the first data block to a media.

2. The electronic storage device of claim 1 wherein a slot is the length of a sector of data.

3. The electronic storage device of claim 1 wherein the FIFO segment is in a DRAM.

4. The electronic storage device of claim 1 wherein the internal processor is an ARM CPU.

5. The electronic storage device of claim 1 wherein the internal processor is configured to allow the R/W system to read the first data block when the first data block is part of a complete sector of data written to the FIFO segment.

6. The electronic storage device of claim 1 wherein the first data block includes a varying data.

7. The electronic storage device of claim 6 wherein the internal processor is configured to write the varying data to a predetermined location within each slot of the FIFO segment.

8. The electronic storage device of claim 6 wherein the first data block includes a predictable data, the internal processor configured to pre-fill the FIFO segment with the predictable data.

9. An electronic storage device for performing high speed R/W testing comprising:
a FIFO segment having multiple slots and configured with a producer pointer and a consumer pointer, the producer pointer configured to indicate the next available FIFO slot to which a test data can be written to, the consumer pointer configured to indicate the next available FIFO slot from which a compare data can be read from;
a media R/W system configured to read the test data from a media and write the test data to the FIFO segment; and
an internal processor configured to read the compare data from the FIFO segment.

10. The electronic storage device of claim 9 wherein the compare data is a portion of a sector of test data written to the FIFO segment.

11. The electronic storage device of claim 9 wherein the compare data includes a varying data.

12. The electronic storage device of claim 11 wherein the internal processor is further configured to compare the varying data read from a predetermined location within each slot of the FIFO segment.

13. The electronic storage device of claim 9 wherein the test data includes a fixed.

14. The electronic storage device of claim 13 wherein the internal processor is configured to:
compare the fixed data with a predicted data after a predetermined number of sectors have been written to the FIFO segment.

15. The electronic storage device of claim 13 wherein the internal processor is configured to:
compare the fixed data with a predicted data when code execution is stalled.

16. An electronic storage device for performing high speed R/W testing using a plurality of FIFO segments comprising:
a first FIFO segment configured to have in integral number of slots, the first FIFO segment configured with a first producer pointer and a first consumer pointer, the first producer pointer configured to indicate the next available FIFO slot to which a data block can be written to, the first consumer pointer configured to indicate the next available FIFO slot from which a data block can be read from;
an internal processor configured to write a first data block to the first FIFO segment;
a second FIFO segment configured to have in integral number of slots, the second FIFO segment configured with a second producer pointer and a second consumer pointer, the second producer pointer configured to indicate the next available FIFO slot to which a data block can be written to, the second consumer pointer configured to indicate the next available FIFO slot from which a data block can be read from, the internal processor configured to write a second data block to the second FIFO segment; and
a media R/W system configured to read the first and second data block from the first and second FIFO segment and write the first and second data block to a media.

17. An electronic storage device for performing high speed R/W testing comprising:
a first FIFO segment having multiple slots and configured with a first producer pointer and a first consumer pointer, the first producer pointer configured to indicate the next available FIFO slot to which a first test data can be written to, the first consumer pointer configured to indicate the next available FIFO slot from which a first compare data can be read from;
a media R/W system configured to read the first test data from a media and write the first test data to the first FIFO segment;
a second FIFO segment having multiple slots and configured with a second producer pointer and a second consumer pointer, the second producer pointer configured to indicate the next available FIFO slot to which a second test data can be written to, the second consumer pointer configured to indicate the next available FIFO slot from which a second compare data can be read from, the media R/W system configured to read the second test data from the media and write the second test data to the second FIFO segment; and
an internal processor configured to read the first compare data from the first FIFO segment and read the second compare data from the second FIFO segment.
